(19) United States
(12) Patent Application Publication
(10) Pub. No.: US 2009/0020205 A1
(43) Pub. Date: Jan. 22, 2009

(54) Tire/wheel assembly for an automobile

(75) Inventors: Michael Cogne, Riom (FR); Laure Simonot, Greenville, SC (US); Jean-Louis Mauclin, Pont-Du-Chateau (FR)

Correspondence Address: FITZPATRICK CELLA HARPER & SCINTO, 30 ROCKEFELLER PLAZA, NEW YORK, NY, 10112, US

(73) Assignee: Michelin Recherche Et Technique S.A., Ch-1763 Granges-Paccot (CH)

(21) Appl. No.: 11/659,008

(22) PCT Filed: Aug. 1, 2005
(86) PCT No.: PCT/EP2005/008311

§ 371 Date: Jan. 30, 2007

(30) Foreign Application Priority Data
Aug. 2, 2004 (FR) 0408558

(51) Int. Cl. B60C 17/06

(52) U.S. Cl. 152/520

(57) ABSTRACT

The present invention relates to a mounted assembly (i.e. tire/wheel assembly) for an automobile vehicle, comprising a rim, a safety support which is mounted on the rim and at least the radially outer face of which is formed of a material of very high modulus, a tire casing mounted on the rim around said support, said rim having on each of its two peripheral edges a rim seat on which is mounted a bead of said casing, and comprising between its two seats a bearing surface receiving said support; this mounted assembly is characterised in that:
the material of very high modulus has a secant tensile modulus at 10% elongation, measured at 80° C. and denoted E10, which is greater than 50 MPa;
the mounted assembly is provided with a lubricating composition having values of viscosity (denoted respectively η₁ and η₂), expressed in Pa·s and measured at 20° C., which satisfy the following relationships:
   at a shear rate of 0.3 s⁻¹: 80<η₁<2500;
   at a shear rate of 10 s⁻¹: 0.1<η₂<35.

### CROSS-REFERENCE TO RELATED APPLICATIONS

This application is a National Phase application of International Application No. PCT/EP2005/008311, filed Aug. 1, 2005, which claims priority to French Application 04/08558, filed Aug. 2, 2004, both of which are incorporated herein by reference in their entireties.

### BACKGROUND OF THE INVENTION

1. Field of the Invention

The present invention relates to the lubrication of an interface between a tire casing (or “tire”) and a safety support made of material of very high modulus mounted on a wheel rim within said tire casing.

It relates more particularly to a mounted assembly for an automobile vehicle, and to the lubrication, in such an assembly, between the safety support and the casing when flat-running following a drop in inflation pressure within said casing.

2. Description of Related Art

In order, when a tire is running at reduced or zero pressure (referred to as “flat-running”), to delay the deterioration due to heating of the zones of friction between various parts of the inner face of the tire casing or alternatively between said face and the metal tire rim, it has been attempted in the past to provide the inner face of the tire casing with lubricating compositions which are intended to reduce the friction between these zones of friction.

Lubricating compositions capable of lubricating tire/tire or rim/tire interfaces have for example been described in the patent specifications FR 2 293 486 (or U.S. Pat. No. 4,051,884) and U.S. Pat. No. 3,946,783. They comprise essentially, in known manner, a lubricating agent, such as for example an alkene oxide polymer (or polyoxyalkene) or glycerin, and a thickening agent, such as for example silica, intended to increase the viscosity of the lubricating agent so as to minimise the flowing of said lubricating agent due to gravity when the vehicle is at rest or is running with its tires inflated.

Attempts have been made more recently to improve the endurance of “mounted assemblies” (i.e., tire/wheel assembly), under conditions of running at reduced or zero inflation pressure, by providing a specific safety support within the tire, mounted on the wheel rim so as to be able to support the tread of the tire in the event of a drop in the inflation pressure. For the description of such safety supports, mention may be made for example of the patent specifications FR 2 746 347 (or U.S. Pat. No. 5,891,279) or WO 00/76791 (or U.S. Pat. No. 6,564,842).

In this context, support/tire lubricating compositions were tested which are more specifically intended to reduce the friction between said support and the inner face of the tire casing surrounding the support, under conditions of flat-running and of load which are harsher and for periods distinctly longer than those relating to the prior tests without a safety support. Such lubricating compositions have for example been described in the patent specifications FR 2 480 201 (or GB 2 074 955), FR 2 415 551 (or GB 2 013 143), WO 02/04237 (or US 2003/087766). These compositions are usually applied to the inner face of the tire casing, prior to its mounting on the rim.

One permanent goal for a manufacturer of mounted assemblies is to reduce the weight of these mounted assemblies and therefore the supports themselves, using relatively “aerated” support structures, i.e. ones which have as little mass as possible, such as described for example in the aforementioned application WO 00/76791.

Pursuing this attempt to reduce the weight nowadays necessitates moving towards using support materials having a very high tensile modulus, typically greater than 50 MPa, preferably greater than 60 MPa, for a temperature close to the operating temperature of a mounted assembly under conditions of flat-running, or approximately 80° C. The use of such materials makes it possible significantly to reduce the thicknesses of the load-bearing structure of the support.

However, owing to this reduction in the sections which transmit the stresses of the tire to the support and therefore to the increase in the resulting contact pressures, the risk of damage to the inner face of the tire casing, when flat-running under very harsh conditions, can no longer be totally avoided, and this is liable to reduce the overall endurance of the mounted assemblies.

### SUMMARY OF THE INVENTION

In continuing their research, the Applicants have discovered specific lubricating compositions, having particular viscosity characteristics, which have proved to meet, in terms of endurance during flat-running, the specific demands of a support of very high modulus capable of generating, when travelling on a flat tire, very high contact pressures between the support and tire, typically greater than 50 bar (for example between 70 and 120 bar) for a load range on said support of between 400 and 800 daN.

Consequently, the invention relates to a mounted assembly for an automobile vehicle comprising a rim, a safety support which is mounted on the rim and at least the radially outer face of which is formed of a material of very high modulus, a tire casing mounted on the rim around said support, said rim having on each of its two peripheral edges a rim seat on which is mounted a bead of said casing, and comprising between its two seats a bearing surface receiving said support, said mounted assembly being characterized in that: the material of very high modulus has a secant tensile modulus at 10% elongation, measured at 80° C. and denoted E10, which is greater than 50 MPa; the mounted assembly is provided with a lubricating composition having values of viscosity (denoted η₁ and η₂ respectively), expressed in Pa·s and measured at 20° C., which satisfy the following relationships:
at a shear rate of 0.3 s⁻¹: 80<η₁<2500;
at a shear rate of 10 s⁻¹: 0.1<η₂<35.

Preferably, the mounted assembly according to the invention is provided with the lubricating composition on the radially inner face of the casing which faces the rim.

### BRIEF DESCRIPTION OF THE DRAWINGS

The invention will be readily understood in the light of the detailed description which follows and the attached figures representing:

FIG. 1: a side view of an example of a safety support intended to be included in a mounted assembly according to the invention;

FIG. 2: a view in axial section of an example of a mounted assembly according to the invention, in which the support of FIG. 1 is mounted on a wheel rim and is in the position of supporting a tire casing;

FIG. 3: a sectional view of an example of an annular body acting as a supporting element for the support, the partitions of which have several inversions of curvature in their width.

### DETAILED DESCRIPTION OF THE INVENTION

In the present description, unless expressly indicated otherwise, all the percentages (%) indicated are mass %.

To fulfil a function of lubrication which is of high performance in terms of endurance of the mounted assembly according to the invention, the lubricating composition (“grease”) used has the essential characteristic of having viscosity values, denoted respectively η₁ and η₂, expressed in Pa·s and measured at 20° C., which satisfy the following relationships:

at a low shear rate of 0.3 s⁻¹: 80<η₁<2500;

at a high shear rate of 10 s⁻¹: 0.1<η₂<35.

This specific lubricating composition has the advantage of not flowing under normal running conditions (i.e., before flat-running) and, when flat-running, of providing lubrication and endurance which are both improved compared with those obtained with the lubricating compositions known hitherto, in the case of safety supports made of a material of very high modulus

The viscosity (η) can be measured using a rotational rheometer of the cone/plate type, for example the rheometer RheoStress® 1 (or “RS1”) sold by Thermo-Haake (coupled to a computer and software for processing the data).

The cone used (C35/4Ti) has a diameter of 35 mm and an angle of 4°. The sample of grease to be analysed is placed in the centre of the plate; after a period of stabilization of the sample of 5 min at a shear rate of 0.3 s⁻¹, the apparent viscosity is measured at a controlled shear rate, by successive stabilization steps of at least 30 s, at shear rates of 0.3, 1.0, 3.0 and 10 s⁻¹. η₁ and η₂ are calculated in known manner by the Rheo Win® software of the rheometer.

Adjusting the viscosity within the ranges advocated above, in addition to the gain in terms of endurance which is provided, furthermore makes it possible to avoid:

owing to excessively high fluidity, the risk of a parasitic flow of the composition at rest, which flow may cause a problem of imbalance during later running under normal conditions (at rated inflation pressure);

owing to excessively low fluidity, the risk of non-uniform distribution of the composition around the safety support, under conditions of flat-running, which is detrimental to the endurance.

Preferably, for all the reasons indicated above, the following relationships are satisfied:

150η₁<2000 and 0.2<η₂<32.

More preferably still, the following relationship is satisfied:

350<η₁<1500.

The lubricating composition having the viscosity characteristics above is preferably based on at least a lubricating agent and a thickening agent.

Preferably, this lubricating agent is selected from the group consisting of mineral oils, silicone oils, glycerin, esters of glycerin and fatty acids, chlorofluorocarbon polymers, polyoxyalkenes and mixtures of these compounds.

More preferably, it is selected from the group consisting of glycerin, polyoxyalkenes and mixtures of these compounds.

One example of a polyoxyalkylene (or polyoxyalkene) which can be used is in particular a polyalkylene glycol. The alkylene (or alkene) is preferably selected from among ethylene, propylene and butylene, in particular from among ethylene and/or propylene. According to a particularly preferred embodiment of the invention, a copolymer or a mixture of polymers of ethylene oxide and propylene oxide is used. In the case of a copolymer, the latter comprises units resulting from ethylene oxide in a preferred molar fraction of 40 to 80% (in particular of 50 to 70%), and units resulting from propylene oxide in a preferred molar fraction of 20 to 60% (in particular of 30 to 50%).

Preferably, the polyoxyalkene used has at least one, more preferably all, of the following characteristics:

a number-average molecular weight (Mn) of between 1,000 and 10,000 g/mol, more preferably between 2,000 and 6,000 g/mol;

a polymolecularity index (Ip) of less than 1.5, preferably less than 1.3 (reminder: Ip=Mw/Mn with Mw being weight-average molecular weight);

an apparent viscosity of between 100 and 1500 mPa·s, preferably between 200 and 1000 mPa·s, said viscosity being measured at 23° C. in accordance with European and International Standard EN ISO 2555 of June 1999 (viscosity in accordance with the Brookfield process; rotational viscosimeter of type A; rotation of 20 rpm; spindle No. 2; model RVT).

The macrostructure (Mw and Mn) of the lubricating agent is determined by steric exclusion chromatography at a temperature of 35° C. (solvent tetrahydrofuran at a flow rate of 1 ml/min; concentration 1 g/l; calibration by mass of polystyrene; detector consisting of a differential refractometer); the molar ratios of ethylene oxide and propylene oxide units are determined in known manner by NMR.

Advantageously a lubricating agent, in particular a polyoxyalkene, of water-soluble grade, which makes it possible if applicable to extract the product, for example from the mounted assembly, by simply washing with water, will be used.

As for the thickening agent, it is preferably selected from the group consisting of silicas, silicates (e.g. bentonite or aluminosilicates), polysaccharides (e.g. cellulose, cellulose derivatives such as for example carboxymethylcellulose, or xanthan gum), alkali salts (Li, K, Na) of fatty acids, rubber and mixtures of these compounds.

Preferably silica, for example a precipitated or preferably fumed silica, is used, such a silica having specific BET and CTAB surface areas which are preferably less than 450 m²/g.

In the present specification, the BET specific surface area is determined by adsorption of gas using the method of Brunauer-Emmett-Teller described in “The Journal of the American Chemical Society” Vol. 60, page 309, February 1938), more precisely in accordance with French Standard NF ISO 9277 of December 1996 (multipoint volumetric method (5 points)—gas: nitrogen—degassing: 1 hour at 160° C.—range of relative pressure p/po: 0.05 to 0.17). The CTAB specific surface area is the external surface area determined in accordance with French Standard NF T 45-007 of November 1987 (method B).

More preferably, a silica having a BET surface area of between 50 and 350 m²/g is used. Beyond 350 m²/g, the endurance of the mounted assembly of the invention may deviate from the optimum, whereas the reinforcement of the composition risks being adversely affected below 50 m²/g. For these reasons, more preferably still a silica having a BET surface area of between 100 and 250 m²/g will be selected.

In order to keep the endurance when flat-running at the best levels, the amount of silica is preferably between 4.0% and 7.5%, more preferably between 4.5% and 7.0%, for example within a range of approximately 5% to 6% of silica. A relatively low amount of silica of approximately 5% (or 5+0.3%) is sufficient in many cases.

One advantageous characteristic of a preferred lubricating composition based on polyoxyalkene and silica, such as described above, is that it does not require the presence of water, which promotes the interaction of the lubricating agent with the thickening agent. It is because of this that it may be referred to as “non-aqueous” or of non-aqueous type, although it can withstand the presence of a small quantity of water without damage. “Non-aqueous” composition is understood in the present application to mean a composition comprising preferably less than 2%, more preferably less than 1% by weight of water (% by weight of lubricating composition).

Preferably, the lubricating composition of the mounted assembly according to the invention is furthermore devoid of any other volatile liquid which is vaporisable at a temperature less than or equal to 150° C., such as for example an alcohol.

This lubricating composition may furthermore comprise, according to the specific embodiments of the invention, various additives such as antioxidants, colorants, bactericides, ionic or non-ionic surfactants, the amount of each of these additives preferably being less than 2% (% by weight of composition).

In the light of the present description and the examples of embodiment, the person skilled in the art will easily be able, by adapting the formulation but also the manufacturing conditions (temperature, speed and duration of mixing) of the lubricating composition selected, to adjust and adapt the viscosities η₁ and η₂ within the recommended ranges.

The lubricating composition previously described is therefore specifically intended for the support made of material of very high tensile modulus, said modulus being greater than 50 MPa (preferably of between 50 and 130 MPa), more preferably greater than 60 MPa (in particular between 60 and 120 MPa).

Unless indicated otherwise, the measurements of tensile modulus are carried out at a temperature of 80° C. in accordance with Standard ASTM D 638 (test piece No. IV): the “true” secant modulus (i.e. reduced to the real cross-section of the test piece), at 10% elongation, referred to as E10 and expressed in MPa, is measured in a second elongation (that is to say after an accommodation cycle), at a traction rate of 200 mm/min.

The material of very high modulus may constitute the entire support or at the very least its outer face in contact with the interior of the casing of the tire under travelling conditions.

Preferably a thermoplastic elastomer (abbreviated to “TPE”) is used which has in particular the advantage of being recyclable, requiring short industrial cycle times for its manufacture, and furthermore having mechanical properties which are readily reproducible.

A TPE elastomer is in known manner a linear elastomeric polymer with processing temperatures of less than 400° C. and the rheological properties of which make it possible to consider methods of transformation such as injection or extrusion. It is characterized for example by a structure comprising two non-compatible phases, one bringing together the thermoplastic sequences of the chain which are thus dispersed in the elastomer phase. Its linear polymer structure may also be composed of rigid crystalline sequences and of flexible amorphous sequences.

Without the list below being considered as limiting, mention may be made of:

sequential styrene/butadiene, styrene/isoprene copolymers;

thermoplastic elastomers derived from polyolefins, physical mixtures of homopolymer or of copolymer of propylene with a non-vulcanized elastomer of type EPM or EPDM (ethylene or propylene rubber);

polyether-polyester amide blocks, a linear regular linkage of rigid polyamide segments and of flexible polyether or polyester segments;

elastomers of polyesters.

Other examples of materials of very high modulus suitable for the supports are steel, aluminium, polyamides, polypropylenes or even polyurethanes of very high modulus, the above polymers being possibly reinforced, in known manner, by reinforcing fillers such as for example glass fibres or beads.

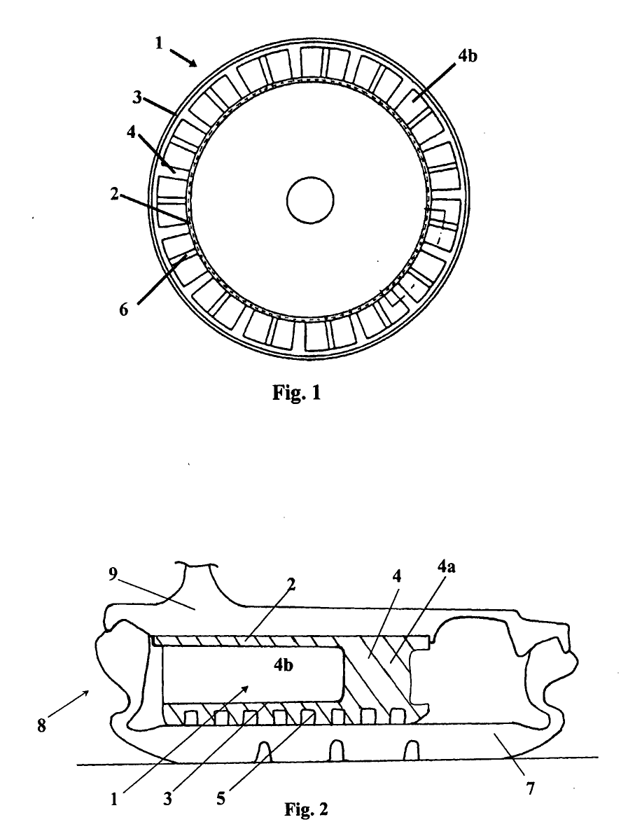

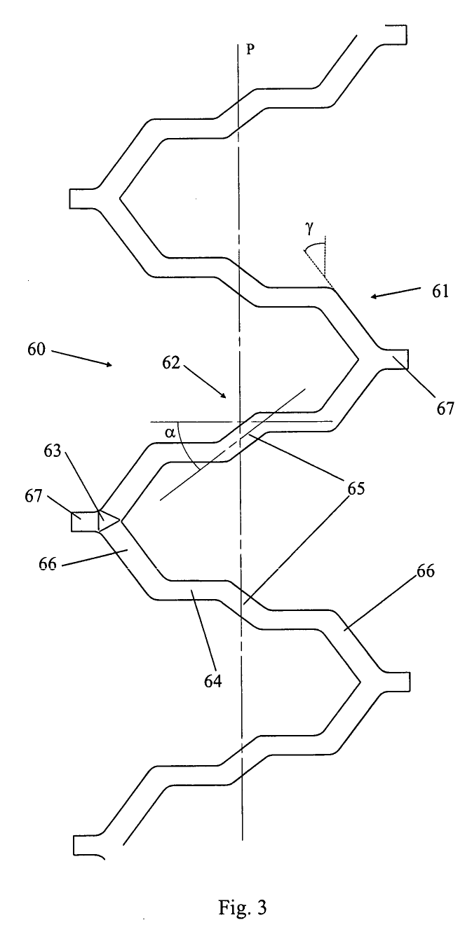

By way of preferred example, the invention is advantageously implemented with safety supports comprising essentially, with reference to the appended FIGS. 1 and 2, a base 2, of generally annular form; a substantially annular crown 3, with longitudinal grooves 5 (optionally) on its radially outer wall, and an annular body 4 for connecting the base 2 and the crown 3.

FIG. 2 illustrates in particular the function of a support 1, which is to support the tread 7 of the tire 8 (mounted on its rim 9) in the event of a serious loss of inflation pressure therefrom.

The section of FIG. 2 shows a specific example of such a support 1, with a first, solid, part 4a of the annular body 4 and also a second part 4b formed of cutouts (see also FIG. 1) extending axially over substantially more than half of the annular body 4, opening on to the outside in a substantially axial direction. These cutouts 4b are distributed regularly over the entire circumference of the annular body 4 and they define partitions 6, which ensure direct radial connection between the crown 3 and the base 2 of the support 1. The cutouts 4b and therefore the partitions 6 are sufficiently numerous to provide regular support during supported travel.

The present invention applies advantageously to a mounted assembly the support structure of which is as disclosed in the aforementioned application WO 00/76791 (or U.S. Pat. No. 6,564,842), comprising in particular:

a substantially cylindrical base intended to be fitted around the rim;

a substantially cylindrical crown intended to come into contact with the tread in the event of a loss of pressure, and leaving a clearance relative to said tread at rated pressure, and

an annular body connecting said base and said crown, said body comprising a supporting element which is circumferentially continuous with a circumferential median plane, said supporting element comprising:
a plurality of partitions extending axially on either side of said circumferential median plane and distributed over the circumference of said support, and
joining elements extending substantially circumferentially and each connecting two ends arranged on the same side of the support of two adjacent partitions, said joining elements being arranged successively and alternately on either side of said partitions,

such a support being characterized in that said partitions are adapted in their central part relative to their lateral ends to reinforce the resistance to buckling under radial loading of said annular body.

The invention applies more particularly to a support in which said partitions have, from one lateral end to the other, several inversions (for example three or four) of the direction of their curvature, in particular in which said partitions have, in their central zone, for example at least two parts extending substantially axially offset circumferentially relative to one another and also a third junction part, as illustrated by way of example in FIG. 3.

This FIG. 3 is a sectional view of an example of an annular body which may serve as a supporting element for the support 1, the partitions 62 of which have several inversions of curvature in their width. More precisely, the partitions 62 comprise rectilinear segments and have at least three inversions of their direction of curvature. They comprise two lateral parts of axial orientation 64, which are connected on one hand by a central part 65 and, on the other hand, to the joining elements 63 by lateral ends 66 of average orientation y close to 30 degrees relative to the circumferential direction. The variation a in average orientation between the two parts 64 of axial orientation of the partitions 62 and the central joining part 65 is for example of the order of 40 degrees.

### EXAMPLES

In the examples of embodiment which follow, the characteristic dimensions (width—internal diameter—height respectively) in mm of each support 1 are: 115-420-45.

Each support 1 is made of material of very high modulus (E10) advantageously greater than 70 MPa at 80° C. It is reinforced by example by a grid (reinforcement armature) composed of several rings such as described in application WO 02/24476 (or US2003/0168142).

The use of this TPE of very high modulus (Hytrele from Du Pont de Nemours—E10 of approximately 75° Pa) made it possible to build a support with very low partition thicknesses, of approximately 6 mm.

Five lubricating compositions C-1 to C-5, in accordance with (C-3 to C-5) or not in accordance with (C-1 and C-2) the invention, were prepared, by adjusting their formulations and/or manufacturing conditions (speed and duration of mixing), in order to vary their viscosities η₁ and η₂ within the ranges indicated in Table I below. For the compositions according to the invention, the mixing was preferably carried out in less than 30 min., at a high shearing stress, with incorporation of the entire thickening agent, in one or more stages, from the start of mixing.

Compositions C-1 to C-4 all comprise 5% to 6% of fumed silica (“Cabosil M5”—BET equal to approximately 200 m²/g) as thickening agent, and, as lubricating agent, a copolymer of ethylene oxide and propylene oxide, sold by Uniqema under the name “Emkarox VG 379W” (viscosity=650 mPa·s−Mn=5500 g/mol−Mw=6800 g/mol, Ip=1.25-molar ratios of ethylene oxide and propylene oxide units of 59% and 41% respectively). In these compositions C-1 to C-4, no additive with the exception of 1% of antioxidant was added to the lubricating compositions, which therefore consist essentially of the above combination of the lubricating agent and silica. The composition C-5 comprises glycerin (78.6%) and water (19.7%) as lubricating agent, 1.6% of xanthan gum as thickening agent and 0.1% of surfactant.

In order then to test the lubricating compositions above when flat-running, the procedure was as follows: identical tires were provided with compositions C-1 to C-5, by applying each of the latter in one and the same determined weight (120 g) over a median zone of the inner face of the corresponding tire, which zone has substantially as its plane of symmetry the equatorial plane of the tire. Then these tires were mounted on identical rims as illustrated in FIG. 2, on which had previously been mounted identical safety supports such as described previously in relation to FIGS. 1 to 3.

The characteristic dimensions of each mounted assembly thus obtained (denoted A-1 to A-5 respectively), intended to be fitted on an automobile of marque “RENAULT” (model “SCENIC”) are in mm: 195-620-420 (width of tire casing—diameter of tire casing—diameter of rim, respectively).

For the requirements of the test, a perforation (using a 6 mm-diameter drill) was made at half-width of the tread of the tire included in each mounted assembly, radially to the inside of a groove bottom of this tread.

Successive running tests for these vehicles, one of the mounted assemblies (front right) (A-1 to A-5 respectively), comprising its specific lubricating composition (C-1 to C-5 respectively), of which is flat running from the start of each test owing to this prior perforation, were then carried out.

The specific conditions of this flat-running were as follows: load on the wheel of 450 kg; average speed of travel of 100 km/h; ambient temperature for travel of 25° C.; travel on a circuit of motorway type.

The criterion for stopping each test is the mileage achieved before destruction of the safety support and/or of the tire casing occurs, or, in the case of a positive test, the achievement of the required minimum mileage (300 km) without damage to the mounted assembly.

It should be noted as a prelude to these tests that the compositions tested C-1 to C-5, therefore including the compositions C-1 and C-2 which are not in accordance with the invention, all exhibit excellent endurance (distance traveled greater than 300 km) in the case of supports made of conventional material of lower modulus (less than 50 MPa at 80° C.), said supports being either of diene rubber (modulus E10 equal to 12 MPa approximately at 80° C.) or of polyurethane (E10 equal to 35 MPa approximately at 80° C.).

The results obtained are set forth in Table 1 below: the endurance result (“D”) is the better, the greater the distance traveled, the indication “D>300 km” simply meaning that the test was stopped after the intended 300 km of flat-running.

TABLE 1

| | | viscosity η₁ | viscosity η₂ | endurance (“D”) |
|---|---|---|---|---|
| Mounted | lubricating | at 0.3 s⁻¹ | at 10 s⁻¹ | when flat- |
| assembly: | composition: | (Pa · s): | (Pa · s): | running: |
| A-1 | C-1 | 1237 | 45 | D < 25 km |
| A-2 | C-2 | 930 | 38 | D < 50 km |
| A-3 | C-3 | 698 | 32 | D < 300 km |
| A-4 | C-4 | 507 | 19 | D < 300 km |
| A-5 | C-5 | 129 | 6 | D < 300 km |

These results clearly demonstrate the superiority of the mounted assemblies of the invention (A-3 to A-5), compared with the control assemblies (A-1 and A-2), each of the mounted assemblies according to the invention having covered a distance greater than 300 km, which is therefore distinctly improved compared with the control mounted assemblies.

The lubricating compositions selected for the mounted assemblies of the invention are therefore capable of providing excellent endurance when flat-running for mounted assemblies in the case of supports made of material of very high modulus, even for a relatively reduced quantity of lubricating composition applied.

The mounted assemblies of the invention in fact have the advantageous characteristic of being able to function with less than 200 g, more preferably less than 150 g, of lubricating composition; quantities less than 100 g (for example of the order of 40 to 80 g) have proved sufficient in numerous cases.

The two a priori contradictory objectives of endurance of the mounted assemblies and use of materials of very high modulus for the supports have thus been “reconciled”.

1. A tire/wheel assembly for an automobile vehicle comprising a rim, a safety support which is mounted on the rim and at least the radially outer face of which is formed of a material of very high modulus, a tire casing mounted on the rim around said support, said rim having on each of its two peripheral edges a rim seat on which is mounted a bead of said casing, and comprising between its two seats a bearing surface receiving said support, characterized in that:
said material of very high modulus has a secant tensile modulus (E10) at 10% elongation, measured at 80° C., which is greater than 50 MPa;
said assembly is provided with a lubricating composition having values of viscosity (denoted η₁ and η₂ respectively), expressed in Pa·s and measured at 20° C., which satisfy the following relationships:
at a shear rate of 0.3 s⁻¹: 80<η₁<2500; and
at a shear rate of 10 s⁻¹: 0.1<η₂<35.

2. The assembly according to claim 1, wherein the following relationships are satisfied:
150<η₁<2000; and
0.2<η₂<32.

3. The assembly according to claim 2, wherein the following relationship is satisfied:
350<η₁<1500.

4. The assembly according to claim 1, wherein the lubricating composition comprises, as lubricating agent, a compound selected from the group consisting of mineral oils, silicone oils, glycerin, esters of glycerin and fatty acids, chlorofluorocarbon polymers, polyoxyalkenes and mixtures of these compounds.

5. The assembly according to claim 4, wherein the lubricating agent is selected from the group consisting of glycerin, polyoxyalkenes and mixtures of these compounds.

6. The assembly according to claim 5, wherein the lubricating agent is glycerin.

7. The assembly according to claim 5, wherein the lubricating agent is a polyoxyalkene.

8. The assembly according to claim 7, wherein the polyoxyalkene is a polyalkene glycol.

9. The assembly according to claim 7 or 8, wherein the alkene of the polyoxyalkene is selected from the group consisting of ethylene, propylene and butylene.

10. The assembly according to claim 9, wherein the polyoxyalkene is a copolymer or a mixture of polymers of ethylene oxide and propylene oxide.

11. The assembly according to claim 10, wherein the polyoxyalkene is a copolymer of ethylene oxide and of propylene oxide, said copolymer comprising units resulting from ethylene oxide in a molar fraction of 40 to 80% and units resulting from propylene oxide in a molar fraction of 60 to 20%.

12. The assembly according to claim 11, wherein said copolymer comprises units resulting from ethylene oxide in a molar fraction of 50 to 70% and units resulting from propylene oxide in a molar fraction of 50 to 30%.

13. The assembly according to claim 7, wherein the polyoxyalkene has a number-average molecular weight of between 1,000 and 10,000 g/mol.

14. The assembly according to claim 13, wherein the polyoxyalkene has a number-average molecular weight of between 2,000 and 6,000 g/mol.

15. The assembly according to claim 7, wherein the polyoxyalkene has a polymolecularity index of less than 1.5.

16. The assembly according to claim 15, wherein the polyoxyalkene has a polymolecularity index of less than 1.3.

17. The assembly according to claim 7, wherein the polyoxyalkene has an apparent viscosity of between 100 and 1500 mPa·s.

18. The assembly according to claim 17, wherein the polyoxyalkene has an apparent viscosity of between 200 and 1000 mPa·s.

19. The assembly according to claim 1, wherein the lubricating composition furthermore comprises, as thickening agent, a compound selected from the group consisting of silicas, silicates, polysaccharides, alkali salts (Li, K, Na) of fatty acids, rubber and mixtures of these compounds.

20. The assembly according to claim 19, wherein the thickening agent is silica.

21. The assembly according to claim 20, wherein the amount of silica is between 4.0% and 7.5%.

22. The assembly according to claim 21, wherein the amount of silica is between 4.5% and 7.0%.

23. The assembly according to claim 20, wherein the silica has a BET specific surface area of less than 450 m²/g.

24. The assembly according to claim 23, wherein the silica has a BET specific surface area of between 50 and 350 m²/g.

25. The assembly according to claim 24, wherein the silica has a BET specific surface area of between 100 and 250 m²/g.

26. The assembly according to claim 1, wherein the lubricating composition comprises less than 2% of water (% by weight of lubricating composition).

27. The assembly according to claim 26, wherein the lubricating composition comprises less than 1% of water (% by weight of lubricating composition).

28. The assembly according to claim 1, wherein said assembly is provided with said lubricating composition on the radially inner face of said casing which faces said rim.

29. The assembly according to claim 1, wherein E10, measured at 80° C., is between greater than 50 and 130 MPa.

30. The assembly according to claim 1, wherein E10, measured at 80° C., is greater than 60 MPa.

31. The assembly according to claim 30, wherein E11, measured at 80° C., is between greater than 60 and 120 MPa.

32. The assembly according to claim 1, wherein the material of very high modulus is a thermoplastic elastomer (TPE).

33. The assembly according to claim 1, wherein said assembly contains less than 200 g of lubricating composition.

34. The assembly according to claim 33, wherein said assembly contains less than 150 g of lubricating composition.

35. The assembly according to claim 34, wherein said assembly contains less than 100 g of lubricating composition.

36. The assembly according to claim 35, wherein said assembly contains from 40 to 80 g of lubricating composition.
